(19) United States
(12) Patent Application Publication
(10) Pub. No.: US 2008/0300998 A1
(43) Pub. Date: Dec. 4, 2008

(54) Method for Online Buying

(76) Inventors: Daniel Harkabi, Foster City, CA (US); Gidon Elazar, Foster City, CA (US); Nehemiah Weingarten, Foster City, CA (US)

Correspondence Address: DAVIS WRIGHT TREMAINE LLP - SANDISK CORPORATION, 505 MONTGOMERY STREET, SUITE 800, SAN FRANCISCO, CA, 94111, US

(21) Appl. No.: 11/756,407

(22) Filed: May 31, 2007

(51) Int. Cl. G06F 15/16; G06Q 30/00; G06Q 20/00

(52) U.S. Cl. 705/26; 709/217; 705/27

(57) ABSTRACT

A digital rights management (DRM) storage device acts as a virtual browser and server functioning as an offline shopping mall. Cookies and similar information stored can be maintained on the DRM device. When attached to an online host (or a host to which it is attached is placed online) the device becomes an automated portal to online shopping (e-shopping) sites. Based on possession of the device, it can act as an authenticator, independent of the need to enter names or passwords. The secure storage ability of the device can also allow it to act as a secure connector with server by securely storing credit card and other sensitive personal information within the DRM device, rather than being maintained on a server associated with a merchant's website, on a personal computer or hosting device, or both.

### CROSS-REFERENCE TO RELATED APPLICATION

The present application is related to U.S. application Ser. No. ______, of Dan Harkabi, Gidon Elazar, and Nehemiah Weingarten, entitled “System for Online Buying,” which is filed concurrently with the present application and is hereby incorporated herein, in its entirety, by this reference.

### BACKGROUND

This invention generally relates generally to the field of online buying and, more particularly, to facilitating the buying process and performing portions of the process prior to going online. All patents, patent applications, articles, books, specifications, other publications, documents and things referenced herein are hereby incorporated herein by this reference in their entirety for all purposes. To the extent of any inconsistency or conflict in the definition or use of a term between any of the incorporated publications, documents or things and the text of the present document, the definition or use of the term in the present document shall prevail.

The Internet World Wide Web implements a client/server model to transfer information from web servers to web clients and vice versa. A Web server is a program that serves web pages as well as other types of content to users running client software known as web browsers. A web page is a document, usually written in Hypertext Markup Language (HTML), that can be accessed on the Internet. Web pages can contain information, graphics, and hyperlinks to other Web pages and files. Web pages may be displayed on a client computing device (hereafter Client Digital Appliance) such as PC, laptops, PDA, mobile phone and any other computational device that can connect to the Internet.

Examples of web servers are Apache, Microsoft's Internet Information Server (IIS), Novell's Web Server, and IBM's family of Lotus Domino servers. Examples of popular web client software (also called web browsers) are Microsoft Internet Explorer and Netscape Navigator. Generally a web server or a collection of web servers provide and/or create and/or transmit over the Internet the information required by the browser to compose and render a requested web page. Therefore in order to retrieve information from a web server, the Client Digital Appliance must be connected to the Internet. The main protocol used to format these requests and responses is called the Hypertext Transfer Protocol (HTTP).

The content sent to the browser can be of several types and formats. It can be static, such as a text file or an image file; HTML (Hyper Text Markup Language) is frequently used to describe static information on a web page. Other types can be streamed data, such as video and audio, which are transmitted as a stream composed of chunks of information, then processed and rendered as received. Another type of information can be a file such as text, video, audio, games, programs, Java applets, or ActiveX controls, all of which may be downloaded from web server to client. Still another format can be user-input dependant and is determined by information sent from client to server, for example a “search” command requested by the client triggers a process in the server to dynamically produce the information to be rendered.

In some cases data is sent from the client to the server for further processing. For example when a user fills out a form on a web page and sends it back to the server. The web server typically passes the form's information to an application program that processes the data. A confirmation message, more forms, and/or more content may be sent to the client as a result. One method or convention for passing data back and forth between the server and the client is called the common gateway interface (CGI) and is part of the World Wide Web's Hypertext Transfer Protocol (HTTP). Microsoft's proprietary interface method is known as an Active Server Page (ASP). Typically, the script in the web page at the server uses input received as the result of the users request for the page to access data from a database and then builds or customizes the page on the fly before sending it to the requester.

The Internet worldwide network, as well as other data communication networks, enables many digital appliances to interconnect and exchange information. Digital appliances include personal computers, laptop computers, tablet computers, personal digital assistants (PDAs), mobile phones, MP3 players, DVD players, gaming consoles, digital recording devices such as digital cameras, and others. A particular use of the Internet, and other networks such as cable and satellite or a corporate or organization network is to browse for and buy merchandise.

In the existing art, the online buying process typically consists of the following or similar steps:

1. Find an online computer or digital appliance.

2. Launch browser application.

3. Enter URL or internet address of online shopping website or choose from favorites stored on the computer.

4. Choose products.

5. Checkout by entering additional information, including, at a minimum, a username and password.

6. Complete transaction.

This arrangement has a number of shortcomings.

The first problem is that the user needs to be online for all the steps of this process. Another problem is that the user needs to remember information such as a URL or website name. Further, “One Click” and similar processes save sensitive user information on both the merchant's server and as an http cookie (information stored on a user's computer by the website) on the PC the user is working from. Additionally, the user is limited to either use the same computer for transactions or else to re-enter information such as username, password, and perhaps credit card information. Consequently, there is room in the art to improve the online buying process by overcoming these limitations.

### SUMMARY

The present invention allows for the use of a portable electronic device having a non-volatile memory and processor to be used in online transactions as an offline shopping mall, for an automated portal process, or both. According to various embodiments, the device's memory can include a hidden portion as well as an open portion, where a digital appliance to which the device is attached cannot directly access the contents of the hidden portion. The memory can be used to store one or more catalogs associated with one or more websites. The hidden portion of the memory can be used to store user related information for completing an online transaction. When the device is connected or otherwise placed in communication with a digital appliance that is online, the device can direct the digital appliance to one of the websites associated with the catalog information. When a user has selected items from the catalog information on the device and performs a checkout process, the device can automatically transfer user related information through the digital appliance from the hidden portion to the associated website.

Additional aspects, advantages and features of the present invention are included in the following description of exemplary examples thereof, which description should be taken in conjunction with the accompanying drawings.

### BRIEF DESCRIPTION OF THE DRAWINGS

FIG. 1 illustrates use of two types of DRM devices with one variety of digital appliance;

FIG. 2 is an electronic block diagram of an example DRM device such as those shown in FIG. 1;

FIG. 3 shows an example division of non-volatile memory in the DRM device of FIG. 2;

FIG. 4 illustrates a method of downloading content into a DRM device from a central provider of the content;

FIG. 5 provides an example of the operation of the DRM device of FIG. 2 to retrieve data of content stored therein; and

FIG. 6 is a schematic block diagram of an exemplary system.

FIG. 7 is a flow chart of an exemplary offline browsing session.

FIG. 8 is a flow chart of an exemplary offline session archiving user input.

FIG. 9 is a flow chart of an exemplary online synchronization process.

FIG. 10 is a flow chart of another exemplary online synchronization process.

FIG. 11 shows a standard prior art e-commerce arrangement.

FIG. 12 shows another e-commerce architecture.

FIG. 13 shows an embodiment of some aspects of the present invention.

FIG. 14 is a flowchart of an embodiment of an automated portal process.

### DETAILED DESCRIPTION OF EXEMPLARY EMBODIMENTS

The present invention uses a digital right management (DRM) type device to overcome some of the shortcomings of the prior art with respect of online buying. The DRM device can be used as an offline “shopping mall”, providing a catalog from which a user can select merchandise even when the hosting digital appliance is offline. The device can also serve as an automatic portal to online shopping sites, act as an authenticator, and be used for the secure storage of credit card and other sensitive information.

To provide context for the present invention, various aspects of DRM devices and their operation are described first, followed by a description of the device as a web server emulator. These discussions are based, respectively on co-pending U.S. patent application Ser. Nos. 11/531,448 and 11/531,445, both filed Sep. 13, 2006, and also on US patent publication number 2004-0210433, where they are developed in more detail. The main presentation of aspects of the invention is then presented.

### DRM Devices and Their Operation

In order to increase the protection of content data files, cryptographic keys and algorithms can be stored and executed in a dedicated DRM device that is separate from the digital appliance with which it operates. This technique is described in United States patent application publication no. 2004/0039932. It is preferably carried out on commercially available memory cards or flash drives as DRM devices, which have their own processing capability. Suitable memory cards are available from SanDisk Corporation, the assignee hereof, which include those sold under its trademarks CompactFlash (CF), Multi-Media Card (MMC), Secure Digital (SD) and miniSD. These memory cards are removably connected with digital appliances through mating connectors that are different for most cards. SanDisk Corporation flash drives, sold under the Cruzer trademark, contain a plug according to the Universal Serial Bus (USB) standard, so can be plugged directly into any digital appliance having a USB receptacle.

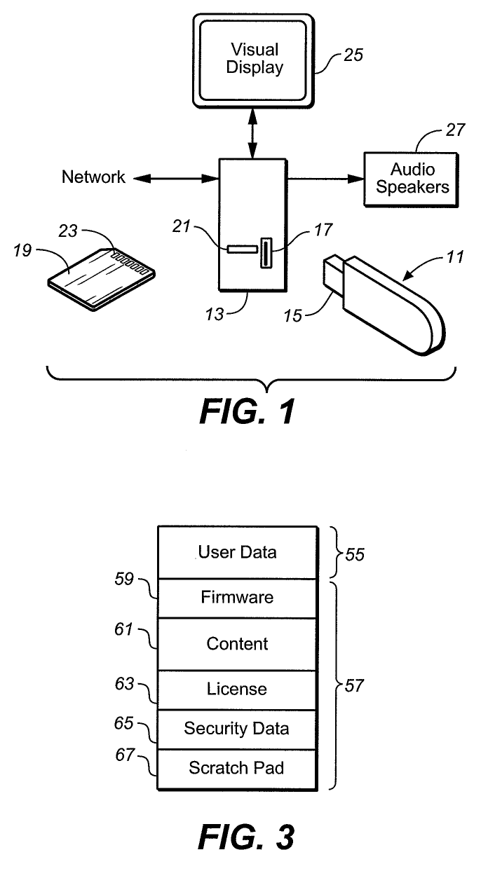

A common form of DRM device 11 and digital appliance 13 are shown in FIG. 1. The DRM device 11 is a flash drive having a USB plug 15 for removable insertion into an USB receptacle 17 on the digital appliance 13, which will commonly be a personal computer, notebook computer or other host that contains an USB receptacle. Of course, other digital appliances may provide similar connectivity for other forms of the memory device. Alternatively, the plug 15 may be in the form of a FireWire connector. Further, wireless communication may be used between the digital appliance 13 and DRM device 11 instead of a wired connection between them.

The use of an SD card 19 as the DRM device is also illustrated in FIG. 1, being removably insertable into a card slot 21 of the digital appliance 13 to electrically connect with its external contacts 23. Some form of memory card adaptor, such as one that also plugs into a USB receptacle of a digital appliance, may be employed instead of utilizing a dedicated card slot on the digital appliance itself.

Another memory storage device very useful for the DRM device is a memory card having two different external connectors on the card that both connect to the internal memory controller, one for insertion into a USB receptacle and another with a standard set of card contacts, such as according to the SD card standards. Such a device is described in U.S. patent application Ser. No. 10/826,801, filed Apr. 16, 2004, entitled “Memory Cards Having Two Standard Sets of Contacts,” and application Ser. No. 11/196,160, filed Aug. 2, 2005, entitled “Memory Card with Two Standard Sets of Contacts and a Contact Covering Mechanism.”

Any visual content of data stored in the DRM device may be viewed by the user on the digital appliance's visual display 25, and any audio content heard through audio speakers 27 or earphones. The digital appliance 13 may include only one of the display 25 or the audio source 27, or multiple copies of one of them, if dedicated to reproduce only visual or audio content, respectively. Some other human sensory transducer may be used when appropriate for reproducing data of a content file stored in the DRM device. Content files and other data are downloaded into the flash memory within either of the devices 11 or 19 through the digital appliance 13 to which they are inserted, when the digital appliance is connected to the Internet or some other network communicating with a source of such data.

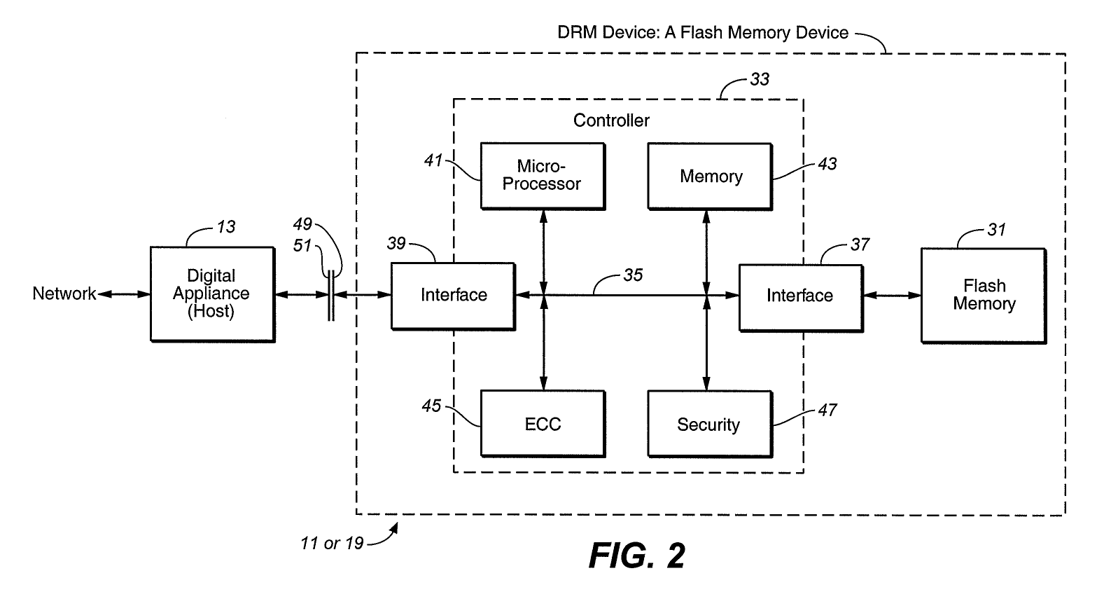

The electronic functions of such a flash memory device 11 or 19 are generally illustrated in FIG. 2. The device contains flash memory 31 having an array or arrays of flash memory cells formed on one or more semiconductor integrated circuit chips. A memory controller 33, usually formed on another chip, typically includes a bus 35 extending between an interface 37 with the flash memory 31 and an interface 39 of the device. Connected to the bus 35 are a micro-processor 41, a memory 43, including volatile random-access-memory (RAM), and typically one or more circuits for making special purpose calculations, such as a circuit 45 for calculating error correction codes (ECCs) from the data and a security processing circuit 47. An external connector 49 is formed on an outside of the memory device, with a mechanically and electrically mating connector 51 on or communicating with the digital appliance 13.

The form of the connector 49 is specific to the standard for the particular memory card or flash drive being used as the DRM device. Many such standards exist. For example, a public document describing the physical and some electrical characteristics of the SD Card is available from the SD Association (SDA): “Simplified Version of: Part 1 Physical Layer Specification Version 1.01,” dated Apr. 15, 2001. Specifications of the TransFlash memory card are available from SanDisk Corporation. Mechanical and electrical details of the USB interface are provided by the “Universal Serial Bus Specification,” revision 2.0, dated Apr. 27, 2000. Another, higher transfer rate interface, known as FireWire, is specified by the following standard of the Institute of Electrical and Electronics Engineers (IEEE): “IEEE Standard for a High Performance Serial Bus,” document no. IEEE 1394-1995, as amended by document nos. IEEE 1394a-2000 and IEEE 1394b-2002.

It is also desirable to manufacture the DRM device in a manner that makes it difficult to be disassembled. This provides additional security of the data stored in it. One such manufacturing technique and a flash drive resulting from it are described in United States patent application publication no. 2004/0137664A1, which application is incorporated herein in its entirety by this reference.

The description above contemplates that the DRM device is implemented in the form of a memory card or flash device that is removable from the digital appliance. However, there are applications where it is desirable to permanently install the DRM device within a digital appliance, an example being where the digital appliance is highly portable such as an audio MP3 player. In such a case, the DRM device is preferably separately formed in a sealed package to increase the difficulty of it being disassembled, thereby increasing the security of the data being processed.

The microprocessor 41 of the controller 33 (FIG. 2) manages operation of the flash memory 31, interfaces with the digital appliance 13, handles the flow of data between the two and processes or supervises the processing of data flowing between the two. The flash memory 31 may be operationally divided in the manner shown in FIG. 3, either physically, logically or with a combination. A segment 55 may be provided for general data storage and, if provided, the digital appliance 13 is allowed by the controller 33 to address this portion of the memory for the general storage of data therein. Another portion 57, the remainder of the memory space in this example, is configured to be inaccessible by the digital appliance. Rather, the hidden portion 57 is accessible by the controller 33 as necessary to carry out requests and commands of the digital appliance 13. The controller 33 has access to the hidden portion 57 of the flash memory in order to perform its functions but this portion is not within the logical address space of the memory device that is seen by the digital appliance 13.

A memory segment 59 may be provided within the hidden portion 57 to store firmware that controls operation of the controller 33. Firmware is loaded from the flash memory 31 into the controller memory 43 as necessary, and then executed out of the memory 43 by the microprocessor 41. Another segment 61 may contain data of the content desired to be retrieved by the digital appliance 13 but these data are transferred to the digital appliance after processing by the controller 33. Data of a license that establishes rules for access and use the content may be stored in a segment 63. Another hidden segment 65 may be provided to store data of encryption keys, a serial number or other unique identification of the device and other security data used to download content data into the memory portion 57 and/or in the retrieval and use of those data by the digital appliance. An additional hidden memory segment 67 may also be included for use by the controller to temporarily store intermediate results of its processing that cannot be accessed by the digital appliance 13.

A wide variety of types of content data exist that may be stored in the memory segment 61. Data of books, magazines and other documents are examples for which the DRM device is quite useful. Data of music, lectures, books and other audio sources can also be stored in a DRM device. Various forms of visual data may also be stored as content, including that of still pictures, movies, television shows and the like. The DRM device may also be used to store data of games or various software applications. In general, any type of data that a user may want to access or use may be stored as content in the DRM device. The DRM device described herein allows the provider of the content to control its use so that the provider may obtain revenue in exchange for allowing its use.

Content may typically be downloaded into the memory segment 61 over the Internet, or some other computer network, through a digital appliance to which the DRM device is connected. License data that specifies allowed use of the content are downloaded into the memory segment 63 in the same manner. License data are usually downloaded as part of the downloading the content, to establish restrictions on the use of the accompanying content. Examples of license restrictions include dates or times that access to the content is permitted, a date that the license terminates, conditions for continuing the license in force and whether the content may be transferred to another DRM device. The controller of the DRM device utilizes the license data to control whether content requested by a user is rendered or not. But what is not controlled is the host or other digital appliance which may be used to retrieve data from the DRM device. Since the DRM device, and thus the content stored on it, are highly portable, its owner may use a wide variety of digital appliances in various locations to access the stored content. The license granted to the user is not restricted to any one digital appliance.

Transfers of content and license data are preferably made over the Internet in an encrypted manner but may be decrypted within the DRM device before being stored in it. The inaccessibility by a digital appliance of the memory segments in which they are stored protects the content and license data from unauthorized access, even if stored in an unencrypted form. They are accessed only by the controller, which then renders the content to the digital appliance without encryption but in a form that is not particularly useful to someone who wants to copy the content data from the DRM device without permission.

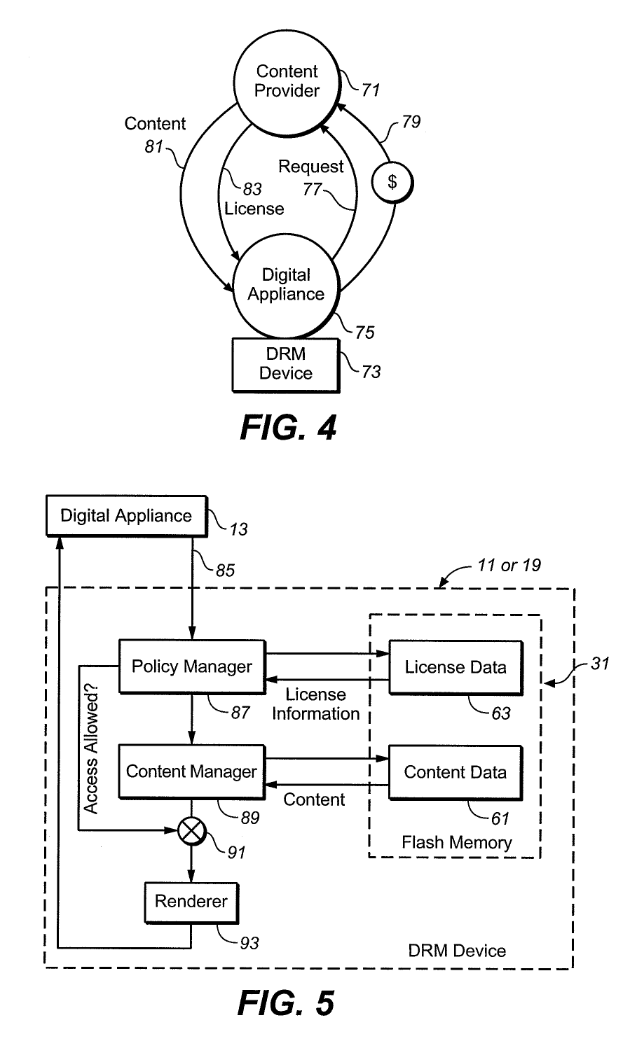

FIG. 4 illustrates the transaction resulting in downloading of new content data from a content provider 71 to a DRM device 73 through a digital appliance 75 to which the DRM device is connected. The DRM device 73 is like the devices 11 or 19 described with respect to FIG. 2. The end user sends a request 77 from his or her computer or other digital appliance 75 over the Internet to the content provider 71 to receive data of a particular item of content. A transfer 79 of funds to pay for the license is also sent, by use of a credit card or some other funds transfer. In return, the requested content 81 and accompanying license 83 are transmitted over the Internet to the digital appliance 75 and stored in the DRM device as illustrated in FIG. 3.

The content so stored in the DRM device 11 or 19 may be utilized in the manner illustrated in FIG. 5, wherein certain functional operations of its controller 33 (FIG. 2) executing its firmware are illustrated. In response to a request 85 from the digital appliance 13 for access to an item of content stored in the flash memory 31, a policy manager 87 accesses the license data stored in the region 63 of the flash memory. The policy manager 87 then determines whether the requested access is in accordance with the permission granted by the license associated with the accessed content. A content manager 89 also accesses the requested content from the region 61 of the flash memory. If the policy manager 87 determines that the requested access is in accordance with the terms of the license, then the data of the requested content are allowed at 91 to pass to a rendering operation 93 to be prepared for output to the digital appliance 13. But if the policy manager 87 determines that access is not permitted by the license, then the access operation stops and an appropriate message sent to the digital appliance 13 to communicate this fact to the end user.

The rendering operation 93 performed by the controller 33 of the DRM device preferably provides an output of the content data to the digital appliance 13 to which it is connected that allows the end user to gain the benefit of the purchased license but which at the same time is not in a form useful for unauthorized copying of the accessed content data. For example, if the content is a book, magazine or other document, the rendering operation 93 sends a picture to the digital appliance 13 of one page at a time, such as in the form of a bit map image. This is all the end user requires in order to be able to read the document but security is maintained since this output is not particularly useful to someone who wants to copy the data being rendered. An unauthorized copier would prefer access to the data as stored in the flash memory 31, an entire data file in some conventional format, rather than having to assemble bit maps of each page into such a file. Similar types of limited data may be provided at the output of the DRM device for other types of content data.

### Web Server Emulation Device

Returning to FIG. 2, this can also be used to illustrate an exemplary embodiment of the Web Server Emulation Device 11 or 19, which includes the microprocessor or central processing unit (CPU) 41, an optional system memory 43, non-volatile storage 31, and an interface 39 to connect the Web Server Emulation Device 11 or 19 to a Client Digital Appliance (Host) 13. There may be only one or a plurality of CPU 41. There may optionally be only one or a plurality of system memory 43 or non-volatile storage 31. There may be only one or a plurality of interfaces 39, the invention is not so limited. The non-volatile storage 31 may be included in the CPU 41 or be discrete from the CPU 41. Generally, components or subcomponents of the Web Server Emulation Device 11 or 19 may be combined with other components or subcomponents of the Web Server Emulation Device 11 or 19 for higher integration and perhaps lower cost.

The CPU 41 may be a general purpose CPU or a CPU with dedicated functions. Furthermore the CPU 41 may include internal memory, and internal non-volatile storage, which in the description of the present invention may serve a similar purpose of the system memory 43, and non-volatile storage 31 respectively. The CPU 41, the non-volatile storage 31, and/or other components may be implemented as a tamper resistant hardware, or sections of the CPU 41, the Flash memory or other non-volatile storage 31, and/or other components may be tamper resistant, the invention is not so limited.

The non-volatile storage 31 may be any of several types of storage including semiconductor based media such as read only memory (ROM), electronic erasable programmable read only memory (EEPROM), flash memory, or battery backed up random access memory (RAM) or the like, or magnetic media storage such as a micro-drive (www.hgst.com/products/microdrive/) or any other type of non-volatile storage, the invention is not so limited.

The non-volatile storage 31 contains instructions that may be executed by the CPU 41. The non-volatile storage 31 may further contain a storage area for digital files. A digital file is data that is stored and/or represented in numerical form.

In various embodiments, Client Digital Appliance 13 may be a personal computer, laptop computer, tablet computer, Personal Digital Assistant (PDA), mobile phone, gaming console or any other computing device with an interface that can be coupled to the Web Server Emulation Device 11 or 19, the invention is not so limited.

The interface 39 can connect the Web Server Emulation Device 11 or 19 with a Client Digital Appliance 13 in both physical and communication aspects. The physical aspect can be, for example directly, or through one or more cables, and/or in a wireless manner. The communication aspect of the interface 39 allows data exchange between the Web Server Emulation Device 11 or 19 and the Client Digital Appliance 13. As before, the interface 39 may be any of several types of interfaces, for example Universal Serial Bus (USB), FireWire, RS-232 or another serial interface, parallel interface, Compact Flash (CF) interface, Sony Memory Stick interface, Multimedia Card (MMC), secure digital (SD), mini SD, Extreme Digital (xD), Bluetooth, WiFi, ultrawide-band, Infiniband, and/or any other type of interface that may be used to connect a Web Server Emulation Device with a client device, the invention is not so limited.

The Client Digital Appliance 13 is used by an end user for some end use, such as web content retrieval from a remote computational device and/or from the Web Server Emulation Device 11 or 19.

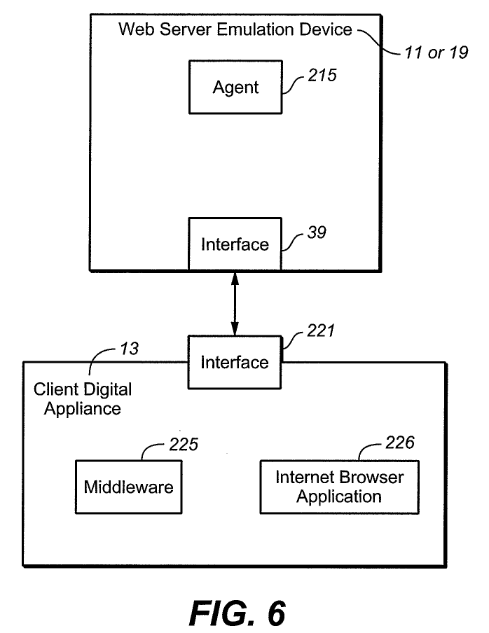

FIG. 6 is an exemplary embodiment of the system, including a Web Server Emulation Device 11 or 19 with interface 39. Client Digital Appliance 13 has an interface 221 matching to interface 39. The Web Server Emulation Device 11 or 19 contains an Agent 215 software code that emulates or partially emulates the behavior of an Internet server. The Client Digital Appliance 13 contains a Middleware 225 software code that dispatches requests to the Agent 215 and gathers responses from the Agent 215. In some embodiments the Middleware 225 processes or partially processes the requests to the Agent 215 and/or the responses from the Agent 215. Requests may originate by user action, for example as result of interaction with a software application, such as an Internet browser, or initiated by other software components executing on Client Digital Appliance 13.

In some embodiments, Middleware 225 captures requests issued by the Internet browser application 226, such as HTTP requests to receive web page information. The Middleware 225 processes or partially processes the captured request and sends one or more requests through interface 39 to an Agent 215 in the Web Server Emulation Device 11 or 19. An Agent 215 in the Web Server Emulation Device 11 or 19 can process requests from a Middleware 225 and respond to such requests.

In some embodiments the Middleware 225 issues requests to the Agent 215 to access data in the non-volatile storage of the Web Server Emulation Device 11 or 19. In some embodiments, the non-volatile storage may be divided into a user storage area and a hidden storage area. The Agent 215 may access data either in the hidden storage area or the user storage area. In some embodiments, the data retrieved by the Agent 215 is forwarded to the Middleware 225 as a response or part of a response to the request issued by the Middleware 225. In other embodiments, the retrieved data is used as a basis for processing and determining the appropriate response. It may be appreciated by those skilled in the art that other alternatives of how an Agent 215 may be used the retrieved data may exist.

In some embodiments, the Middleware 225 makes itself accessible to other programs executing on the Client Digital Appliance 13, for example an Internet browser application 226, by registering as a network node, with its own TCP/IP address and/or communication port. For example, in some embodiments the Middleware 225 may identify itself using an address range 127.0.0.x (x is a value forming a valid address), which in many computer systems is defined as the loopback address range, an address local to the computer. Additionally, the emulation may identify itself as port 80 on that address, which is the standard HTTP port that is referred to by default by Internet browsing programs. In some embodiments, the Middleware 225 identifies itself with the TCP/IP address of the Client Digital Appliance 13, or with any other address and/or port, or with no address, the invention is not so limited.

In some embodiments, once the Middleware 225 is identified with a TCP/IP address, the Internet browser application 226 can be directed to browse a URL that resolves to the defined TCP/IP address and/or communication port. In such a case, all requests issued by the Internet browser application 226 are directed to the Middleware 225, which may capture and manage an appropriate response. In some embodiments, Middleware 225 will communicate the Agent 215 to produce or partially produce the response. In other embodiments, the Middleware 225 may respond to an Internet browser 226 request without accessing the Agent 215.

In may be appreciated by those skilled in the art that there are additional methods to make Middleware 225 available to other programs executing on Client Digital Appliance 13, the invention is not so limited.

In some embodiments, the Agent 215 and/or Middleware 225 respond to requests for HTTP messages, such as generated by Internet browser 226. In other embodiments, the Agent 215 and/or Middleware 225 respond to other types of requests that are commonly responded to by web servers, such as FTP, NFS, email request such as MAPI, POP mail, SNMP, data streaming, content streaming and the like protocols or any combination of the above, this invention is not so limited.

In some embodiments, the Middleware 225 may also respond to local API (Application Program Interface) requests received from an application without the use of a web server protocol.

The Middleware 225 may respond to requests initiated locally on the Client Digital Appliance 13 or on a remote computational device, in such cases when the Client Digital Appliance 13 is connected to a network, such as the Internet network.

It may be appreciated by those skilled in the art that the Middleware 225 may be implemented in a variety of forms, for example, as one program, as a plurality of programs, as a module within a program and the like, and that there exist a variety of ways for the Middleware 225 to capture requests without departing from the spirit of this invention.

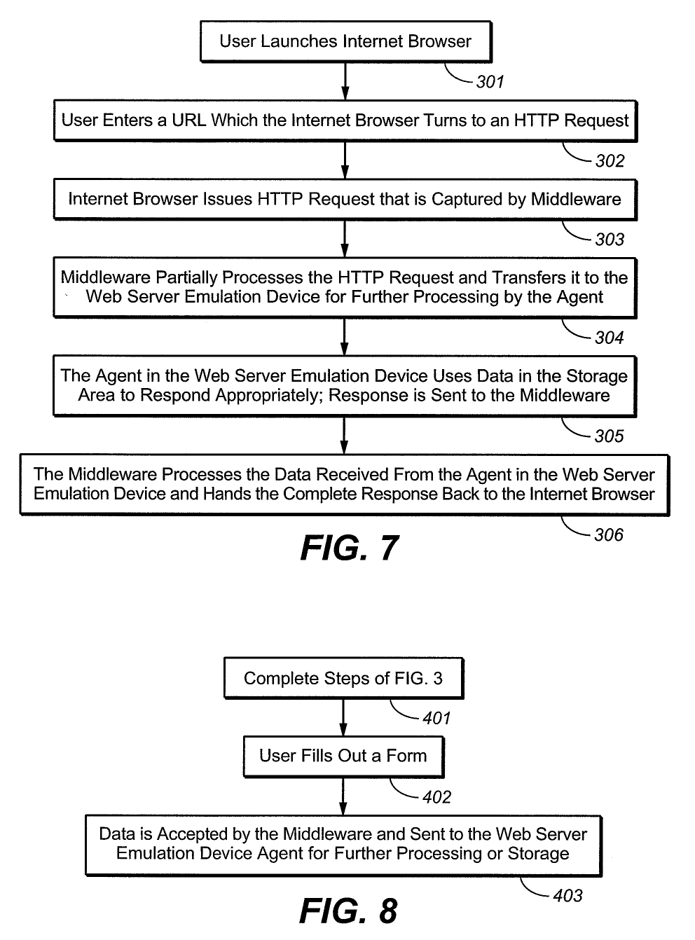

FIG. 7 is a flow chart describing an exemplary sequence of operations carried out when a user browses a web site using the Web Server Emulation Device 11 or 19. In step 301 the user launches a web browsing application, for example Microsoft Internet Explorer, on the Client Digital Appliance 13.

In step 302 the user enters a URL that directs the browser to the Middleware 225, either by including the TCP/IP address and/or port that the Middleware 225 was identified with, or by including a URL that will be resolved to the Middleware 225, or by any other method that can be captured by the Middleware 225.

In step 303 the web browser sends an HTTP request, for example a GET request, that is captured by the Middleware 225.

In step 304 the Middleware 225 partially processes the request, for example parses it, and forwards the original request or the processed request or a plurality of requests to the Agent 215 in the Web Server Emulation Device 11 or 19 for further processing.

In step 305 the Web Server Emulation Device 11 or 19 uses some data, for example a digital file stored in the hidden storage area, and optionally involving one or more Agents 215 to respond to the request, for example by sending a digital file together with some processed information back to the Middleware 225.

In step 306 the Middleware 225 processes the data received from the Web Server Emulation Device 11 or 19, for example adds an HTTP header and sends the complete response back to the web browsing application, for example in order to render a web page.

In the above exemplary flow chart, those skilled in the art may appreciate that the Client Digital Appliance 13 may or may not be connected to a network, such as the Internet. Furthermore, in some embodiments, the Middleware 225 may process the request without necessitating any processing from the Web Server Emulation Device 11 or 19, or without doing any processing prior to forwarding the request to the Web Server Emulation Device 11 or 19. In some embodiments, the Middleware 225 may receive requests from a remote computational device, such as a remote computer over a network.

According to some embodiments, the processing done by the Web Server Emulation Device 11 or 19 includes retrieval of a digital file from the hidden storage area. In other embodiments there is no data retrieval from the hidden storage area.

FIG. 8 is a flow chart describing an exemplary sequence of operations carried out when a user enters data to be stored on the Web Server Emulation Device 11 or 19. Step 401 completes the sequence of FIG. 7 in order to retrieve and render an input form.

In step 402 the user enters data to entries in the form.

In step 403 the data is sent to the Agent 215 through the Middleware 225. The Agent 215 may use the data for processing a response and/or storing the data in the nonvolatile storage and/or manipulating the data in the form.

In other embodiments, the steps of FIG. 7 are not necessary, and it may not be required to retrieve the form from the Web Server Emulation Device 11 or 19 prior to accepting user inputs. In some embodiments, the Web Server Emulation Device 11 or 19 stores the user input in the user storage area or in the hidden storage area.

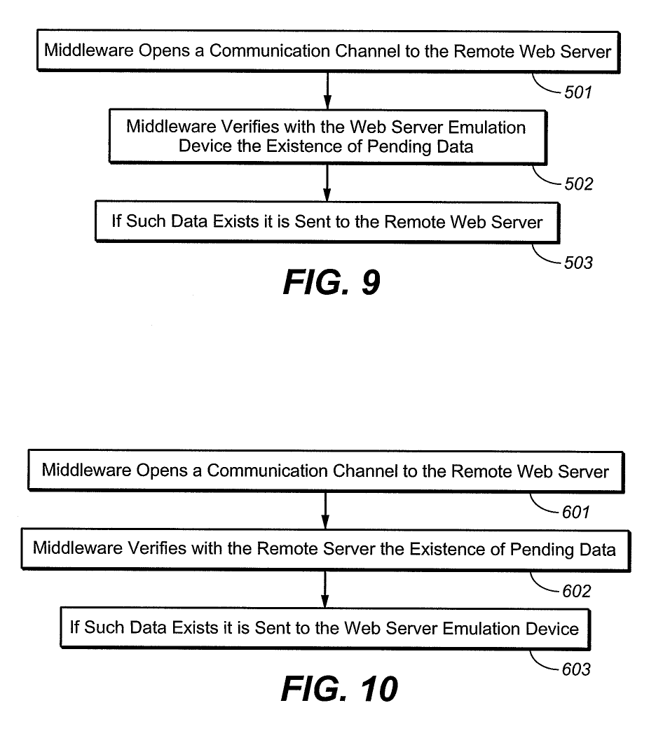

FIG. 9 is a flow chart describing an exemplary sequence of operations carried out when the user data is sent to a remote server, In step 501 the Middleware 225 opens a communication channel to a remote web server.

In step 502 the Middleware 225 verifies that there is user data stored on the Web Server Emulation Device 11 or 19.

In step 503 the Middleware 225 retrieves the user data from the Web Server Emulation Devices 11 or 19 and sends it over the network to the remote web server.

In some embodiments, the Middleware 225 first checks the availability of user data on the Web Server Emulation Device 11 or 19. In some embodiments a software program distinct from Middleware 225 initiates the communication to the remote web server, and uses the Middleware 225 to communicate with the Agent 215 in order to complete the transfer, the invention is not so limited.

In some embodiments the data on the Web Server Emulation Device 11 or 19 is encrypted or compressed by the Agent 215 prior being sent to the Middleware 225.

FIG. 10 is a flow chart describing an exemplary sequence of operations carried out when a remote server sends data to the Web Server Emulation Device 11 or 19. In step 601 the Middleware 225 opens a communication channel to a remote web server.

In step 602 the Middleware 225 verifies that there exist data from the remote web server for the Web Server Emulation Device 11 or 19.

In step 603 the Middleware 225 receives the data from the remote server and sends it to the Web Server Emulation Device 11 or 19.

In some embodiments, the Middleware 225 first checks the availability of data on the remote server, the invention is not so limited.

This exemplary sequence may be initiated automatically, for example every time a Web Server Emulation Device 11 or 19 is connected to a Client Digital Appliance 13 that is connected to a network, or initiated by user, the invention is not so limited.

In some embodiments, an authentication process may be executed as well. The authentication process ensures that data from the remote server reaches only the Web Server Emulation Device 11 or 19 intended.

### Online Buying

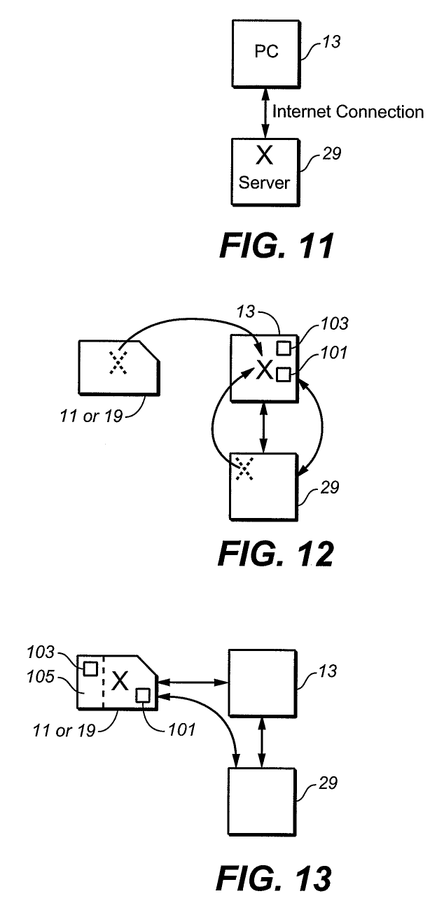

The online purchase of merchandise, as found in the prior art, can be illustrated with the use of FIG. 11. FIG. 11 shows a host, such as a PC or other digital appliance, 13. To engage in online buying or similar processes, the PC 13 would need to be online and connected to a server 29 (typically a number of computers connected with a database) over the Internet. The e-commerce site, represented by the X, resides on the server 29 of the retailer, where sensitive data on the user would typically be maintained.

As noted in the Background section, this arrangement has a number of shortcomings. A first of these is the user actually needs to be online for the process, which limits its portability and convenience. Additionally, a user needs to remember or re-obtain information such as a URL or website name. An easier way to get to an online store and shop could provide online vendors a better opportunity to improve chances of getting people onto their websites. Further, common online shopping processes (such as “One Click” and similar processes) save sensitive user information on both the merchant's server and as a cookie on the PC the user is working from. The present invention can avoid this (including the storage of corresponding cookies on the PC being used) by maintaining such sensitive information on the device in secure areas. In the arrangement of FIG. 11, the user is also limited to either use the same computer for transactions or else to re-enter information such as username, password, and perhaps credit card information.

Some of these problems, specifically, having to be online to browse the site, can be ameliorated by effectively moving the e-commerce site, along with some of the browser/server functions, from the server to the PC or other digital appliance. The e-commerce site could be provided to the host 13 from the server 29 while it is online. It could also be provided from portable device 11 or 19 without the need to be online at the time, a arrangement similar in some respects to what is found in US patent publication number US 2004/0199575 A1 (which has many additional details that may be incorporated here). This situation is illustrated in FIG. 12. Here the host 13 now houses the virtual e-commerce site, acting as a virtual website/browser, as again shown by the X. This e-commerce site has been loaded from the server 29 or portable device 11 or 19 (indicated by the X being ghosted) and is now resident on the digital appliance 13, where it will reside and be executed (hence the ghosting on 29 and 11 or 19). Once loaded, the actual use of the application would then involve either activities solely on the computer 13, such as browsing a catalog, or interactions between the computer 13 and the server 29. The portable device 11 or 19 only server to supply material to the host 13 (where it is executed), after which it is no part in the proceedings.

Although the arrangement of FIG. 12 improves over that described with respect to FIG. 11 by allowing for offline usage, it is still limited in a number of ways. For example, the process is now tied to an intermediate server (a specific host or PC 13). Thus, although the medium 11 or 19 could be taken to another host and loaded there, any cookies or other identifying information placed by the server 29 on the host 13 would not be present on the new host for use in later transactions. Similarly, any user data would be resident on host 13. Consequently, the arrangement of FIG. 12 still lacks portability as any cookies 101 or user data 103 is tied to the host 13 and would not be available to any new hosting device. By contrast, the present invention maintains the e-commerce site on the portable device 11 or 19, from which it is executed, allowing the device to go into any system, with everything on this portable device, instead of being tied to a specific digital appliance. As with the arrangement of FIG. 11, that of FIG. 12 still causes any residual sensitive information in 101 or 103 to be left on the PC 13.

In its various embodiments, the present invention overcomes these difficulties by using a DRM storage device, such as that presented in US patent publication number US-2006-0080535-A1. According to one aspect, the DRM storage device acts as a virtual browser and server functioning as an offline shopping mall. In contrast to the embodiment described with respect to FIG. 12, cookies and similar information stored by the website can be maintained on the DRM device. In another aspect, when attached to an online host (or a host to which it is attached is placed online) the device becomes an automated portal to online shopping (e-shopping) sites. Based on possession of the device, it can act as an authenticator, independent of the need to enter names or passwords. The secure storage ability of the device can also allow it to act as a secure connector with server by securely storing credit card and other sensitive personal information within the DRM device, rather than being maintained on a server associated with a merchant's website, on a personal computer or hosting device, or both.

Offline Shopping Mall

In this aspect of the invention, a catalog is maintained on the portable device, enabling it to serve customer with the catalog items even when offline. The catalog can either be preloaded on the device, downloaded once the user has the device, or some combination of these. For example, when the device is connected to an online computer, a catalog is downloaded (or undated) by a server to the device. This enables serving customer with the catalog items even when offline. The customer can complete an order including payment. All the information can be securely stored on the device. The next time the device is plugged to an Internet connected host, the transaction can take place, for example using the automated portal process described below. Until the device is connected though the host to the appropriate merchant's website, the actual transaction does not take place, but will occur with the information being sent during the connection.

This can be illustrated with the use of FIG. 13. As in FIG. 12, FIG. 13 again shows a server 29, a host 13, and a detachable device 11 or 19, which is now a DRM-type device. In this arrangement, the e-commerce site and the other virtual elements (indicated by the X) now reside on the device 11 or 19, with the host 13 functioning more or less as just a display and command input device. Any cookies or similar data 101 from the server will also reside on the hand-held or portable device. The offline catalog content can be preloaded on the device, downloaded from a server, or some combination. For example, an initial version of the catalog may be preloaded, but then updated when the device in attached to a host that is online at the time. Any sensitive user data 103 can be maintained securely in the hidden portion (105) of the device 11 or 19.

Automated Portal Process

The automated portal process again begins by finding an online computer or other host in step 701. (Alternately, a host to which the DRM device is already attached can be placed on line, basically switching the order of steps 701 and 703.) In step 703, the DRM device is attached to the host, by plugging it into a USB port for example, resulting in the automatic launching of the DRM/browser application. More generally, the device need not be physically attached by a connector as long a communication channel, such as through a wireless connection interface, is established.

In step 705, the device and application automatically redirects the user to an online shopping site. This may be a particular shopping site associated with the device. In other embodiment, the user may be presented with several sites from which to choose, such as through extra buttons added when a catalog is downloaded or updated. If products have already been chosen using the offline shopping mall, the redirection would be to the corresponding site. This automatic process again differs from the prior art arrangement where a user must type in the URL or internet address of a desired site. Additionally, as any cookies or other information 101 from previous transactions has previously stored on the device 11 or 19, it will be available even if the website has not been accessed before using the current host.

In step 707 the user selects products for acquisition. This user could also do this prior to the going online by using the offline shopping mall, in which case this step would be automatic by the device, rather than a separate step actively done by the user. Also, the approaches can be combined, where selections made offline can be augmented online. The products purchased may digital, such as would be used on the DRM device, or physical, which could be sent by mail.

The checkout process is completed as step 709 without entering any additional user information (credit card, account numbers, etc.) 103, as these can already be on the device 11 or 19 where they can be securely maintained. This differs from the prior art arrangements that require additional information be entered (user name, passwords, at a minimum, as well as credit card, account numbers, etc., if these are not maintained by the site on its server) to checkout. It should be noted that in alternate embodiments, additional input could be required in step 709, if desired. The transaction is completed at 711 by, say, clicking an OK, completing the transaction with the merchant.

As noted with respect to step 705, the redirection may be based on a particular site with which the card is associated. This can be offered to existing online shopping sites. For example, an SD card, say, could be a membership card for ordering online from specific merchants.

### CONCLUSION

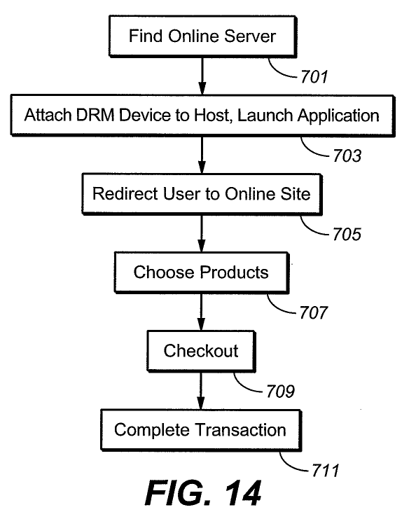

Although the various aspects of the present invention have been described with respect to exemplary embodiments thereof, it will be understood that the present invention is entitled to protection within the full scope of the appended claims. Particularly, modifications of the example transactions described above primarily with respect to FIGS. 11-14 may be made to accommodate other specific situations.

It is claimed:

1. A method of operating an electronic device that includes a processor, an interface for operable communication with any one of a plurality of digital appliances for utilization of the data content and a non-volatile memory including a hidden portion that is not within an address space of the memory accessible by a digital appliance with which the device is in communication but is accessible by the device processor, wherein the non-volatile memory includes ones or more catalogs associated with one or more websites, the method comprising:
placing the device in communication with a digital appliance;
placing the digital appliance online in communication with the internet;
in response to the device being placed in communication with said online digital appliance, the device directing the digital appliance to one of said associated websites based on information stored on the device;
selecting one or more items from one of said catalogs, where said one of the catalogs is maintained on the device; and
performing a checkout process, wherein the hidden portion includes user related information for completing an online transaction and the device automatically transfers at least a portion of said user related information through the digital appliance to said one of the associated websites.

2. The method of claim 1, wherein said placing the digital appliance online in communication with the internet precedes said placing the device in communication with the digital appliance.

3. The method of claim 1, wherein said placing the digital appliance online in communication with the internet is subsequent to said placing the device in communication with the digital appliance.

4. The method of claim 1, wherein said catalogs specify a corresponding internet address for each of said associated websites.

5. The method of claim 1, wherein said user related information includes credit card information.

6. The method of claim 1, wherein said user related information includes account information.

7. The method of claim 1, wherein said user related information includes password information.

8. The method of claim 1, further comprising:
downloading the one or more or said catalogs onto the device prior to said selecting one or more items.

9. The method of claim 8, wherein said downloading is performed while the device is in communication with said digital appliance.

10. The method of claim 8, wherein said downloading is performed while the device is in communication with a digital appliance other than said digital appliance.

11. The method of claim 1, further comprising:
supplying said user related information to the device prior to performing said checkout process.

12. The method of claim 11, wherein said supplying said user related information is performed while the device is in communication with said digital appliance.

13. The method of claim 11, wherein said supplying said user related information is performed while the device is in communication with a digital appliance other than said digital appliance.

14. The method of claim 1, wherein said selecting one or more items is performed prior to placing the device in communication with said digital appliance.

15. The method of claim 14, wherein the associated website to which the device directs the digital appliance is based on said one or more selected items.

16. The method of claim 1, wherein said selecting one or more items is performed subsequent to placing the device in communication with said digital appliance.

17. The method of claim 1, wherein the one or more selected items include physical merchandise.

18. The method of claim 1, wherein the one or more selected items include digital merchandise.

19. The method of claim 1, wherein said interface includes a connector by which the electronic device may be detachably connected with the plurality of digital appliances.

20. The method of claim 1, wherein said interface is for wireless communication channel communication with the plurality of digital appliances.

21. The method of claim 20, further comprising:
storing of information on the device by said one of the associated websites while the device is in communication with the digital appliance that is online in communication with the internet.

22. The method of claim 1, wherein said information stored on the device by said one of the associated websites is an http cookie.

23. A method of operating system including, a digital appliance connectable to the internet and an electronic device operably connectable to the digital appliance, wherein the electronic device includes a processor and a non-volatile memory including a hidden portion that is not within an address space of the memory accessible by the digital appliance when the device is in communication therewith but is accessible by the device's processor, the method comprising:
storing user related information for completing an online transaction in the hidden portion of said device;
placing the device in operable connection with the digital appliance;
placing the digital appliance online in communication with the internet; and
while the device is in operable connection with the digital appliance and the appliance is in communication with the internet, performing an online transaction with a website, wherein the device automatically transfers at least a portion of said user related information through the digital appliance to said website without storing the portion of said user related information on the digital appliance.

24. The method of claim 23, wherein the device includes a connector and said placing the device in operable connection with the digital appliance includes detachably connecting the device with the connector.

25. The method of claim 23, wherein said placing the device in operable connection with the digital appliance is through a wireless connection.

26. The method of claim 23, further comprising:
storing of information on the device by said website while the device is in operable connection with the digital appliance and the appliance is in communication with the internet.

27. The method of claim 26, wherein said information stored on the device by said one of the associated websites is an http cookie.

28. The method of claim 23, wherein the non-volatile memory includes ones or more catalogs, said website being associated with one or more of said catalogs, wherein in response to the device being placed in communication with said online digital appliance, the device directs the digital appliance to said websites based on information stored on the device

29. The method of claim 28, wherein said catalogs specify a corresponding internet address said website.

30. The method of claim 23, wherein said user related information includes credit card information.

31. The method of claim 23, wherein said user related information includes account information.

32. The method of claim 23, wherein said user related information includes password information.

33. The method of claim 23, further comprising:
selecting one or more items from one of said catalogs, where said one of the catalogs is maintained on the device; and
downloading the one or more or said catalogs onto the device prior to said selecting one or more items.

34. The method of claim 33, wherein said downloading is performed while the device is in communication with said digital appliance.

35. The method of claim 33, wherein said downloading is performed while the device is in communication with a digital appliance other than said digital appliance.

36. The method of claim 23, further comprising:
supplying said user related information to the device prior to performing said online transaction.
